(19) United States
(12) Patent Application Publication
(10) Pub. No.: US 2017/0226786 A1
(43) Pub. Date: Aug. 10, 2017

(54) DUAL SLIDING DOOR SYSTEM

(71) Applicant: Robert Mayer, Boca Raton, FL (US)

(72) Inventors: Robert Mayer, Boca Raton, FL (US); Jose Suero, Boca Raton, FL (US)

(21) Appl. No.: 15/040,016

(22) Filed: Feb. 10, 2016

(51) Int. Cl. E05D 15/06; A47K 3/00; E05F 5/00

(52) U.S. Cl. CPC E05D 15/0643; E05D 15/0656; E05F 5/003; A47K 3/006; E05Y 2900/114

(57) ABSTRACT

A dual sliding door apparatus incudes a rectangular shaped frame configured for attachment to two opposing walls and a floor, the frame creating an opening, a top of the frame comprising a first rail parallel to a second rail, a first glass door sized so as to cover about one half of the opening, a pair of roller wheels coupled to a top of the first door, the pair of roller wheels including a concave outer surface designed to mate with the first rail, such that the first door rolls on the first rail, a second glass door with a pair of roller wheels coupled to a top of the second door, a first stop coupled to an outer circumference of the first glass door, and a second stop coupled to an outer circumference of the second glass door.

### CROSS-REFERENCE TO RELATED APPLICATIONS

Not Applicable.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The present invention relates to the field of home and commercial furnishings, and more specifically to doors.

### BACKGROUND

A sliding door is a type of door which opens horizontally by sliding, whereby the door slides on a track. Sliding doors are commonly used for shower doors, glass doors, screen doors, and wardrobe doors. Traditional sliding doors have two panel sections, one fixed or stationary and one mobile to slide open. The actual sliding door is a movable rectangular framed sheet of window glass that is mounted parallel to a similar and often fixed similarly framed neighboring glass partition. The movable panel slides in a fixed track usually, and in its own plane parallel to the neighboring stationary panel. Conventional sliding doors can be a product of design but mainly fill a functional role for the typical consumer.

One of the problems associated with conventional sliding doors, especially when used for shower or bathtub enclosures, arises when the track becomes obstructed with debris or buildup, or simply becomes old, crooked or rusted. This is a common problem in bathroom situations that involve a lot of moisture, soap scum buildup, mildew and the like. When such situations arise, it can be difficult or impossible to slide the doors open or closed due to the problems with the track. This often leads to necessary repairs or replacement, which can be expensive and time consuming

As a result, there exists a need for improvements over the prior art and more particularly for a more efficient sliding door apparatus, especially for shower or bathtub enclosures.

### SUMMARY OF THE INVENTION

A dual sliding door apparatus is disclosed. This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

In one embodiment, the dual sliding door apparatus incudes a rectangular shaped frame configured for attachment to two opposing walls and a floor, the frame creating an opening configured for ingress and egress into a shower enclosure, a top of the frame comprising a first rail parallel to a second rail, a first glass door sized so as to cover about one half of the opening, a pair of roller wheels coupled to a top of the first door, the pair of roller wheels including a concave outer surface designed to mate with the first rail, such that the first door rolls on the first rail, a second glass door sized so as to cover about one half of the opening, a pair of roller wheels coupled to a top of the second door, the pair of roller wheels including a concave outer surface designed to mate with the second rail, such that the second door rolls on the second rail, a first stop coupled to an outer circumference of the first glass door, wherein the first stop extends outwards such that it prevents the second door from rolling past the first stop, and a second stop coupled to an outer circumference of the second glass door, wherein the second stop extends outwards such that it prevents the first door from rolling past the second stop.

In another embodiment, the dual sliding door apparatus incudes a rectangular shaped frame comprising a bottom bar, a right side bar, a left side bar, and a top portion including a first rail parallel to a second rail, a first door sized so as to cover about one half of the opening, a pair of roller wheels coupled to a top of the first door, the pair of roller wheels including a concave outer surface designed to mate with the first rail, such that the first door rolls on the first rail, a second door sized so as to cover about one half of the opening, a pair of roller wheels coupled to a top of the second door, the pair of roller wheels including a concave outer surface designed to mate with the second rail, such that the second door rolls on the second rail, and the second door is parallel to the first door, a first stop coupled to an outer circumference of the first door, wherein the first stop extends outwards such that it prevents the second door from rolling past the first stop and, a second stop coupled to an outer circumference of the second door, wherein the second stop extends outwards such that it prevents the first door from rolling past the second stop.

Additional aspects of the disclosed embodiment will be set forth in part in the description which follows, and in part will be obvious from the description, or may be learned by practice of the disclosed embodiments. The aspects of the disclosed embodiments will be realized and attained by means of the elements and combinations particularly pointed out in the appended claims. It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. The embodiments illustrated herein are presently preferred, it being understood, however, that the invention is not limited to the precise arrangements and instrumentalities shown, wherein:

FIG. 1 is a perspective view of a dual sliding door apparatus comprising double doors in a closed position, according to one embodiment;

FIG. 2 is a frontal view of the apparatus of FIG. 1, according to one embodiment;

FIG. 3 is another perspective view of the apparatus of FIG. 1, according to one embodiment;

FIG. 4 is a close-up perspective view of the upper left hand corner of the apparatus of FIG. 1, according to one embodiment;

FIG. 5 is a close-up perspective view of the upper right hand corner of the apparatus of FIG. 1, according to one embodiment;

FIG. 6 is a close-up perspective view of the upper middle section of the apparatus of FIG. 1, according to one embodiment;

FIG. 7 is a perspective view of the rear/right side door of the apparatus of FIG. 1, according to one embodiment.

FIG. 8 is a perspective view of the front/left side door of the apparatus of FIG. 1, according to one embodiment;

FIG. 9 is a perspective view of the frame of the apparatus of FIG. 1, according to one embodiment;

FIG. 10 is a side view of the apparatus of FIG. 1, according to one embodiment;

FIG. 11 is a top view of the apparatus of FIG. 1, according to one embodiment;

FIG. 12 is a top view of the apparatus of FIG. 1 installed in a shower enclosure, according to one embodiment; and

FIG. 13 is a perspective view of the apparatus of FIG. 1 showing a close-up view of the bottom of the frame, according to one embodiment.

### DETAILED DESCRIPTION

The following detailed description refers to the accompanying drawings. Whenever possible, the same reference numbers are used in the drawings and the following description to refer to the same or similar elements. While disclosed embodiments may be described, modifications, adaptations, and other implementations are possible. For example, substitutions, additions or modifications may be made to the elements illustrated in the drawings, and the methods described herein may be modified by substituting reordering, or adding additional stages or components to the disclosed methods and devices. Accordingly, the following detailed description does not limit the disclosed embodiments. Instead, the proper scope of the disclosed embodiments is defined by the appended claims.

The disclosed embodiments improve upon the problems with the prior art by providing a sliding door apparatus that eliminates the need for a track, thereby eliminating the problems associated with said tracks. The disclosed embodiments also include a stopper for stopping the doors from moving too far along the railing. The disclosed embodiments further improve over the prior art by providing a small sliding door apparatus that fits effortlessly in small areas that require an enclosure, such as showers and bathtubs. Additionally, the invention improves over the prior art by providing a sliding door apparatus that is easily and inexpensively fabricated, while using a minimal number of parts. Finally, the invention improves over the prior art by providing a sliding door apparatus that is minimalistic in design and provides an uncluttered and simple view.

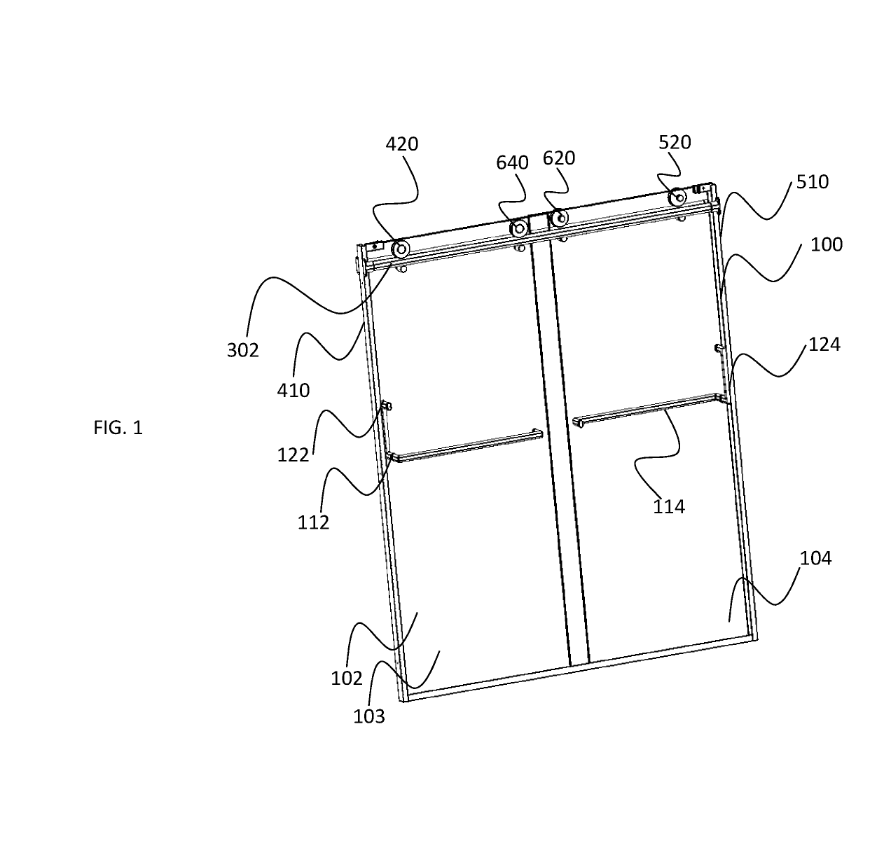

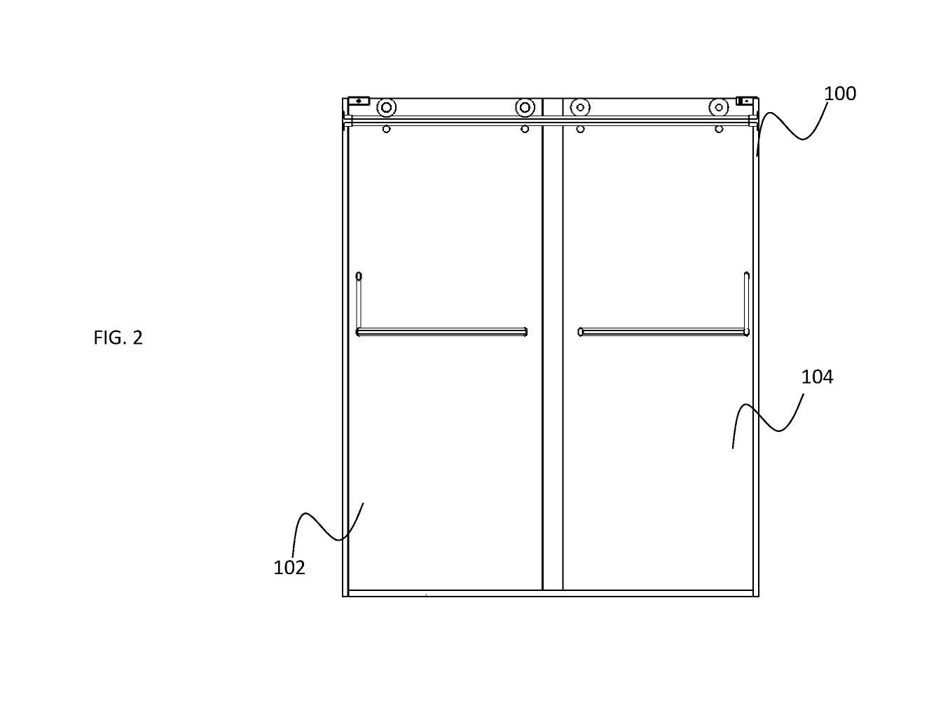

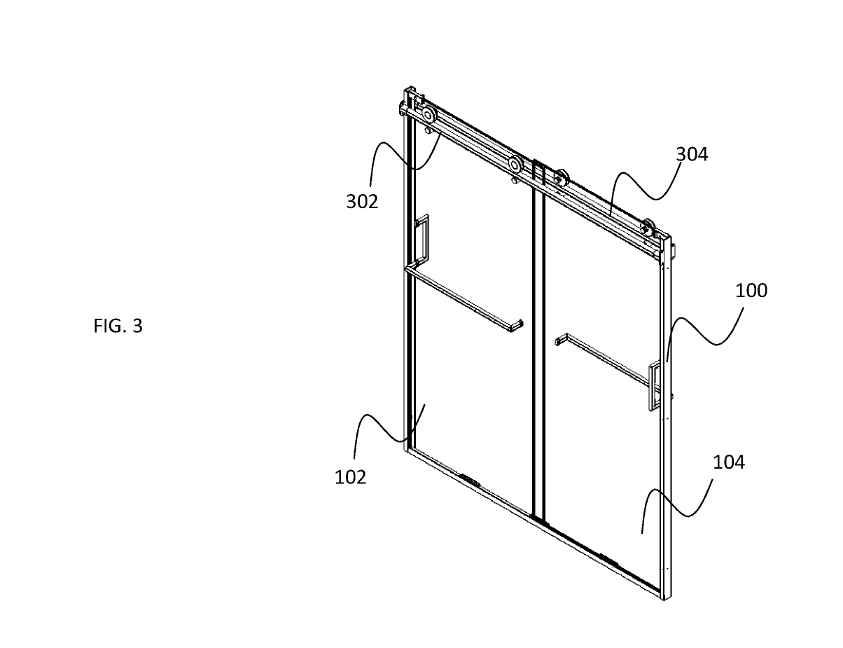

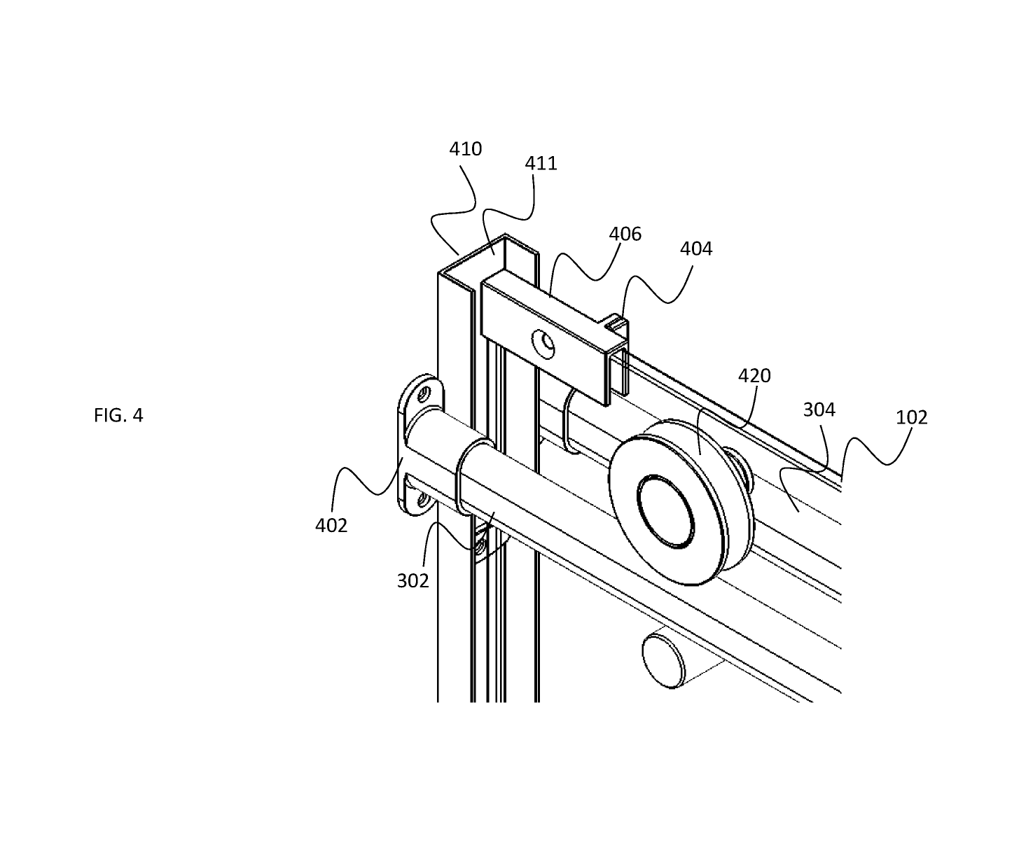

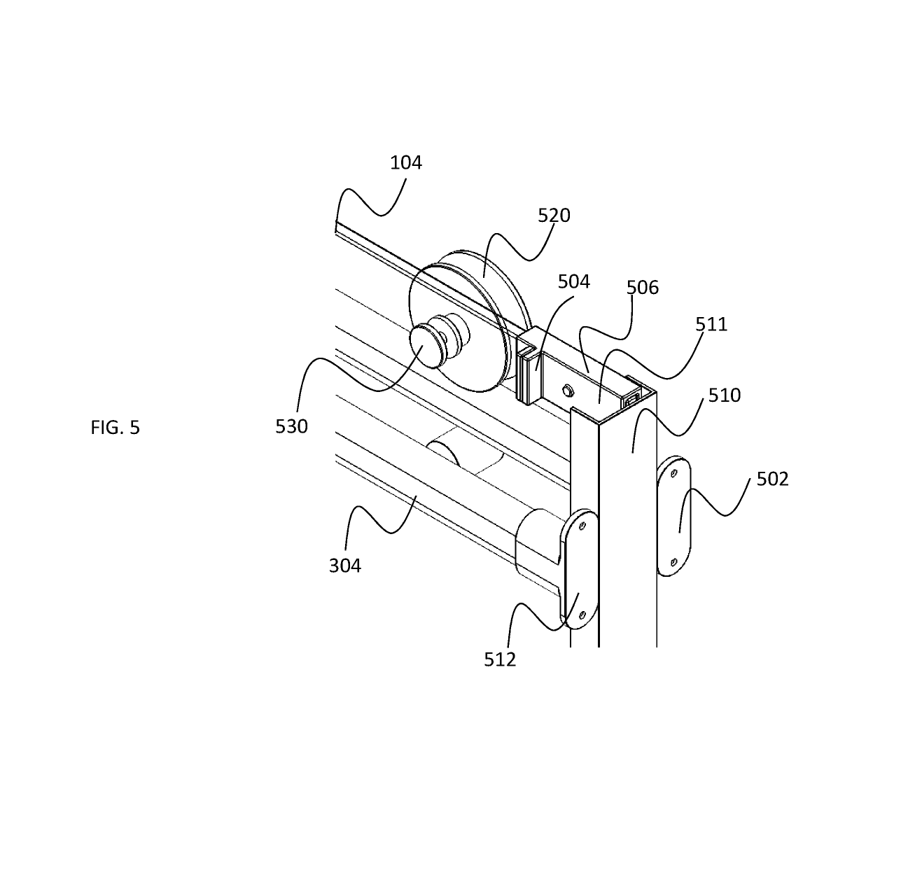

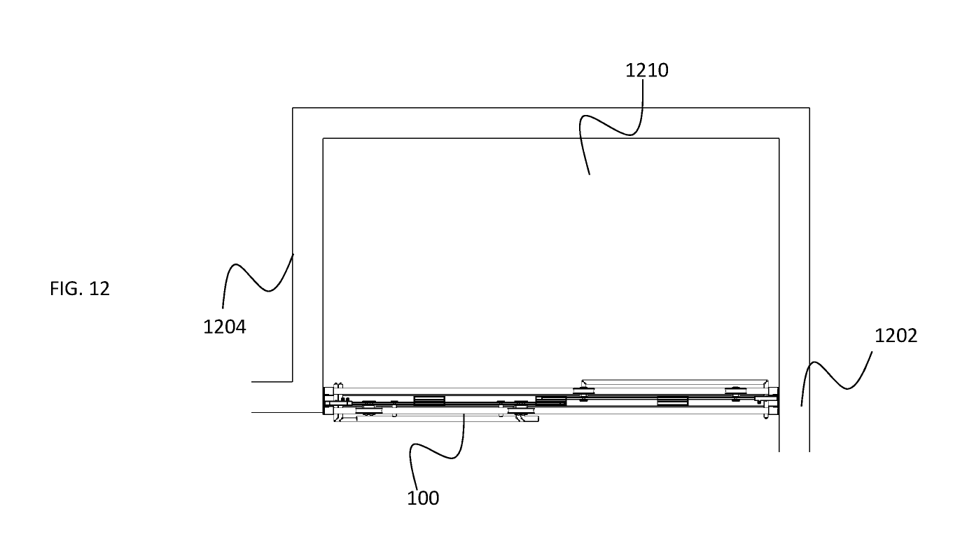

Referring now to the Figures, FIGS. 1-3 will now be discussed together. The sliding door system may be used to define a shower enclosure 1210 (see FIG. 12) and to provide and restrict access into the enclosure. The sliding door system 100 includes a frame structure that may include a left bar or frame 410 (more clearly illustrated in FIG. 4) and an opposing right bar or frame 510 (more clearly illustrated in FIG. 5), as well as a top portion and a bottom frame 902, all of which define an opening to a shower, or bathtub enclosure. The left and right frames are vertically aligned and configured to be coupled to opposing walls of a shower (as illustrated in FIG. 12). A horizontally aligned front rail 302 and horizontally aligned rear rail 304 (parallel to the front rail) are configured to span between the left and right frames proximate to the upper end of the left and right frames. Each end of the front and rear rails are configured to be attached to opposing walls of a shower (as illustrated in FIG. 12). Each of the frames and rails may comprise material such as wood, aluminum, metal alloys, plastic, corrugated paper, or any other rigid material such as those well known to those skilled in the art. Each of the frames and rails may be coupled to the walls of the shower by a fastener, such as a screw, bold, nail etc. and are well known to those skilled in the art.

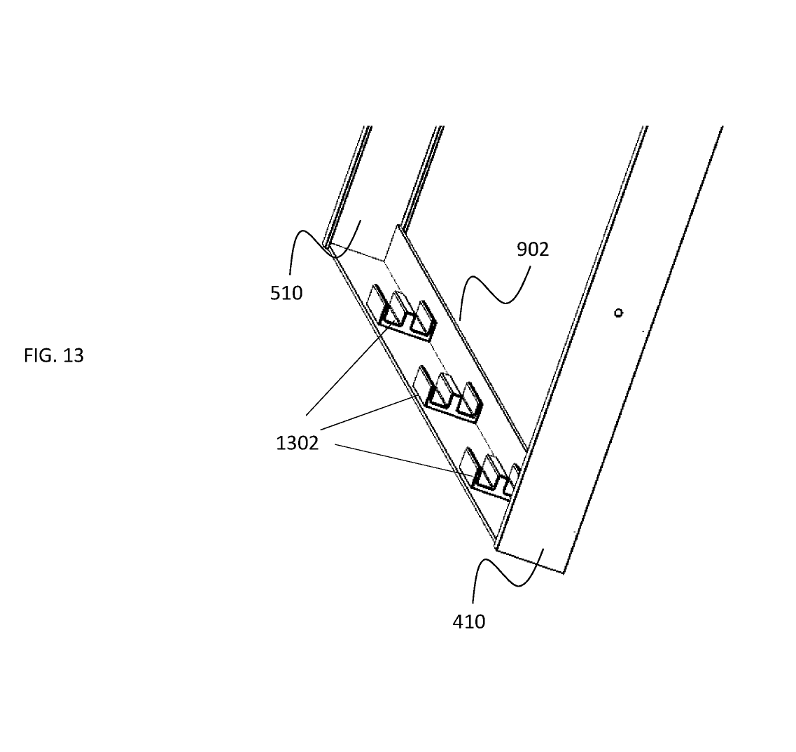

The right side bar and the left side bar of the rectangular shaped frame may have U-shaped cross sections (see detail of FIGS. 4 and 5). The frame structure that may also include a top portion comprising the rails 302, 304 and a bottom bar or frame 902 with an L-shaped cross section (see detail of FIG. 13).

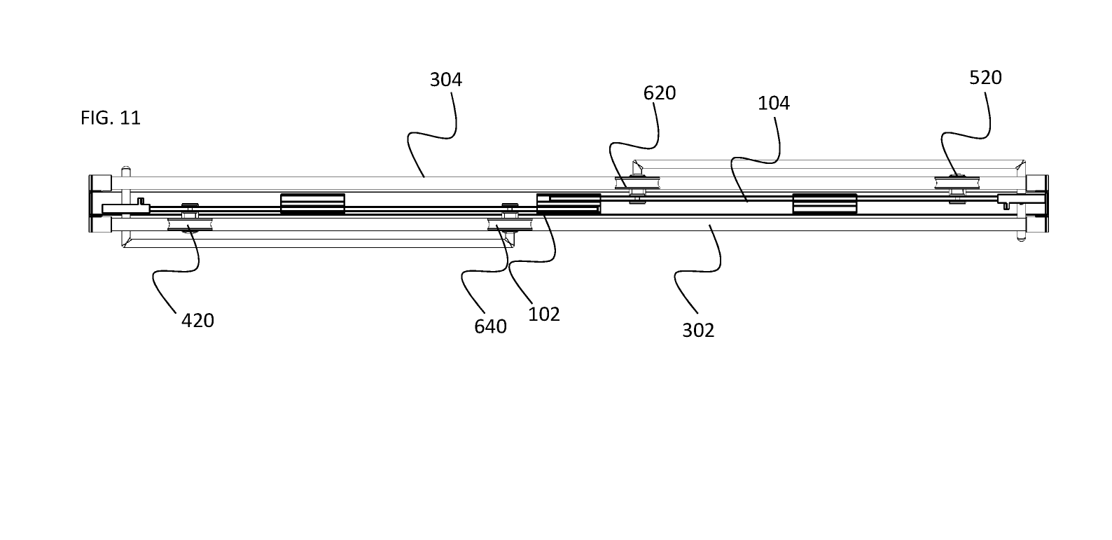

The sliding door system comprises a vertically aligned front or left side door 102 positioned in front of and parallel to a vertically aligned rear or right side door 104. The left and right doors are positioned in between the front and rear parallel aligned rails (shown in FIG. 11). Each of the doors are substantially planar. The front or left side door is configured to be hung from the front rail 302 by rollers 420, 640 and the rear door is configured to the hung from the rear rail 304 by rollers 620, 520 such that the doors nay be horizontally moved along the rails (further explained below). In operation, and in a closed position, as illustrated in FIGS. 1-3, the doors do not substantially overlay one another. When the apparatus is in the closed position the doors are arranged so as to obstruct substantially the entire opening made by the frame. When in the open position (not shown), the doors will overlay each other thereby allowing access or providing an opening between the left and right frame. When the apparatus is in the open position the doors are arranged such that substantially half of the opening is free from obstruction. Although in a preferred embodiment the doors are comprised of glass, tempered glass, safety glass, etc., each of the doors may comprise other material such as wood, plastic, aluminum, alloys, or any other combination thereof and are well known to those skilled in the art.

In the present embodiment, the front door includes a horizontal handle 112 coupled to the frontward facing surface 103 of the front door. The horizontal handle of the front door is configured for allowing a user to grasp the handle and apply force from the forward facing side of the front door such that the front door can be horizontally moved. The horizontal handle may also be used to drape towels or other wet materials. Additionally, a vertical handle 122 may be coupled to the front door such that the vertical handle is configured for allowing a user to grasp the handle from the rearward facing surface of the front door so that the front door can be horizontally moved.

Similarly, the rear door includes a horizontal handle 114 coupled to a rearward facing surface 105 of the rear or right door 104. The horizontal handle of the rear door is configured to allow a user to grasp the handle and apply force from the rearward facing surface of the rear door so that rear door can be horizontally moved. Additionally, a vertical handle 124 may be coupled to the frontward facing surface of the rear or right side door such that the vertical handle is configured for allowing a user to grasp the handle from the frontward facing surface of the right side door rear so that the rear or right side door can be horizontally moved. Each of the handles may be attached to the doors using means well known to those skilled in the art, such as glue, screw, bolts etc.

FIGS. 4 and 5 will be discussed together. FIGS. 4 and 5 are enlarged perspective views of the corners of the upper ends of the sliding door system. FIGS. 4 and 5 further illustrate how the doors 102, 104 are hung onto the rails 302, 304. FIG. 4 illustrates the vertically aligned left frame 410. In the present embodiment, the left frame is an elongated U-shaped body. The U-shaped body defines channel 411 which is configured for receiving the side of the doors. FIG. 4 illustrates the left side or front door 102 positioned towards the frontward end of the U-shaped body of the left frame 410. FIG. 4 illustrates that the left frame 410 is positioned between the front rail 302 and rear rail 304. A mount 402 is configured for mounting the left side end of the front rail to a wall. FIG. 4 illustrates a roller 420, or roller wheel, including a concave outer surface designed to mate with the rail 302, such that the door 102 rolls on the rail. The roller is rotatably coupled proximate to the upper end of the door. Said rails 302, 304 may comprise rounded cross sections designed to mate with the concave outer surface of the rollers or roller wheels.

In the present embodiment, a corner 406 is coupled to the corner of the front or left side door. The corner defines a body that straddles the corner of the door and includes a stop 404 that protrudes perpendicularly rearward from the body of the corner. The stop is configured for stopping the rear or right side door 104 from sliding horizontally. In the present embodiment, the stop may also include a cushion or bumper having forces absorbing properties to decrease the amount of force exerted on the corner, wherein the cushion may be rubber. In one embodiment, the cushion may a sponge, plastic, compression spring, air spring, or any other material that is able to absorb force when activated. Stop 404 may include a rubber bumper coupled configured to contact the other door.

In the present embodiment, each roller is configured to roll along the rail. In operation, when the doors are placed into position, the rollers are positioned on top of and mate with the rails. A support is rotatably coupled to the surface of the doors and position positioned below the rail such that the rail is positioned between the roller and the support. In the present embodiment, the doors may slide along the rail without the supports, however, the supports provide additional support for heavier doors.

Similarly, FIG. 5 illustrates the right frame 510 receiving the rear or right side door 104. In the present embodiment, the right frame is an elongated U-shaped body. FIG. 5 illustrates the right frame member 510. The U-shaped body defines channel 511 which is configured for receiving the side of the doors. FIG. 5 illustrates the right or rear side door 104 positioned towards the rearward end of the U-shaped body of the right frame 510. FIG. 5 illustrates how the right frame 510 is positioned between the front rail 302 and rear rail 304. Mounts 512, 502 are configured for mounting the right side of the front rail and rear rail, respectively, to a shower wall. FIG. 5 illustrates roller 520. The roller is rotatably coupled to proximate to the upper end of the door by coupling 530. In the present embodiment, a corner 506 is coupled to the corner of the rear or right side door. The corner 506 defines a body that straddles the corner of the rear door and includes a stop 504 that protrudes perpendicularly frontward from the body of the corner and towards the front of the sliding door system. The stop is configured for stopping the front side door 102 from sliding horizontally. In the present embodiment, the stop may also include a cushion having forces absorbing properties to decrease the amount of force exerted on the corner. In one embodiment, the cushion may a sponge, plastic, compression spring, air spring, rubber or any other material that is able to absorb force when activated. Stop 504 may include a rubber bumper coupled configured to contact the other door.

In the present embodiment, each mount 402, 510, 502 comprises a tubular shaped body having a flanged end and an open end. The open end of each tubular shaped body is configured for receiving the end of a rail. The flanged end of the mount is configured for coupling the rail to the wall. In the present embodiment, the flanged end of the mount includes an aperture on each side of the tubular shaped body. Fasteners may be used to fasten the mount to the shower wall.

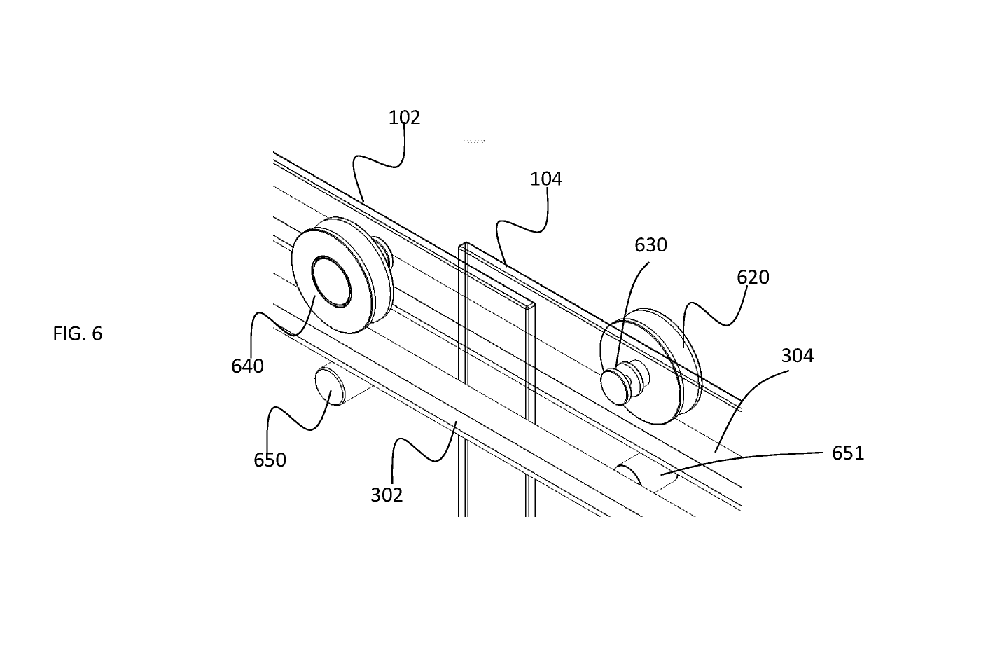

Referring now to FIG. 6, FIG. 6 is a zoomed in or enlarged view of the middle section of the sliding door system when the doors are in the closed positon. FIG. 6 illustrates the front door 102 positioned in front of the rear door 104 and both doors are in between the front rail 302 and rear rail 304. FIG. 6 also illustrates that the front rail 302 is positioned between roller 640 and support 650 that are rotatably coupled to and protrude from the frontward facing surface 103 of the front door, such that the rail is supported by 650. Roller 640 is rotatably coupled and extends frontward to interact with front rail 302. Roller 620 is rotatably coupled by coupling 630 to the rear door. Rear rail 304 is positioned between roller 620 and a support 651, which are rotatably coupled to and protrude from the rearward surface 105 of the door, such that the rail is supported by 651. Roller 620 extends rearward so that it can interact with rear rail 304. In operation, in order to move the sliding door system between an open and closed position, force is applied such that rotatable connections of the rollers and supports rotate allowing the rollers of the front or rear door to slide along the rails. In operation, as a door is opened, a door moves horizontally towards the other door's stop. As the door moves toward the stop an opening between the left and right frames is created, which serves as an opening to enter into a shower enclosure. The protruding nature of the stop prevents the door from sliding into the frame.

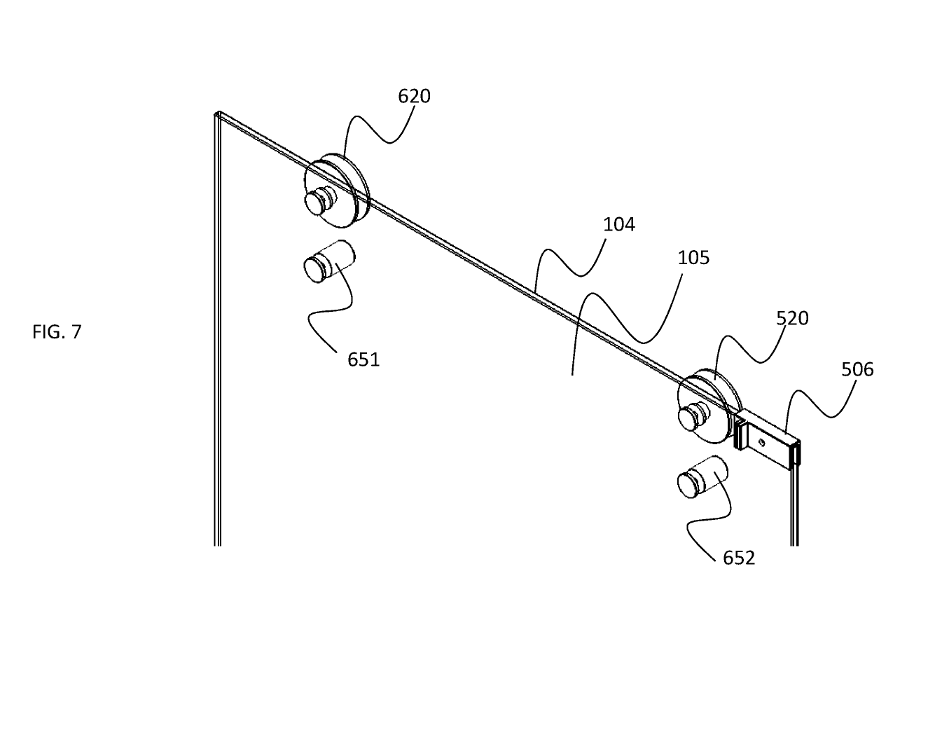

FIG. 7 is a perspective view of a rear door 104 of the sliding door system. The door is unattached or uncoupled from the rail. FIG. 7 illustrates that supports 702, 704 and rollers 620, 520 protrude rearward (away from the front door if fully assembled). The rollers and supports are rotatably attached to the door. The rollers may comprise a pair of wheels aligned parallel and connected by a pin or similar mechanism which is rotatably connected to the upper end of the door. The area between the parallel aligned wheels define a catching feature that latches onto the rail when the door is vertically aligned and positioned such that rail is below the wheel.

Each support comprises a cylindrical shaped body coupled to a pin that is rotatably attached to the door. In operation each support may provide additional support for heavier doors and further guide doors along the rails. Corner member 506 is attached to the corner of the rear or right side door. In the present embodiment, corner member comprises a body adapted to straddle the corner of the door and includes a stop protruding frontward (towards the front door when the sliding door system is fully assembled). As mentioned above, the stop may include a cushion that is configured to absorb forces when the front door slides into the cushion. It is understood that the supports, corners, rollers, of the rear or right side door may also be used for the left side or front door.

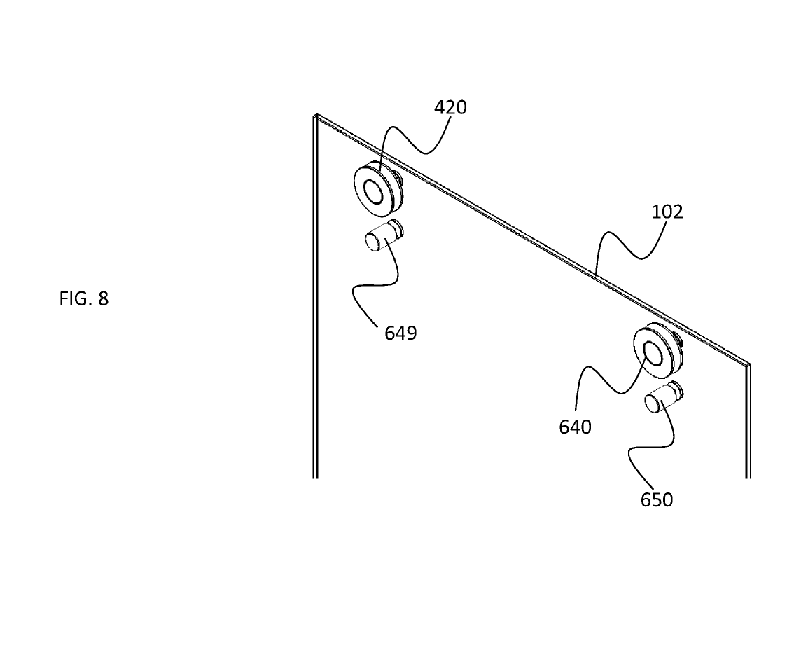

FIG. 8 is a perspective view of a front or left side door of the sliding door system attached or uncoupled from the rail. FIG. 8 illustrates that supports 802, 804 and rollers 420, 640 protruding frontward (away from the rear door if fully assembled). The rollers and supports are rotatably attached to the door. The rollers may comprise a pair of wheels aligned parallel and connected by a pin or similar mechanism which is rotatably connected to the door. Each support comprises a cylindrical shaped body coupled to a pin that is rotatably attached to the door. In operation the support may provide additional support for heavier doors and further guide doors along the rails. FIG. 8 does not include a corner member on the door. However, it should be noted that a corner (as illustrated in FIG. 5 as 506 and explained above) may be attached to the corner of the rear or right side door. As mentioned above, the stop may include a cushion that is configured to absorb forces when the front door slides into the cushion.

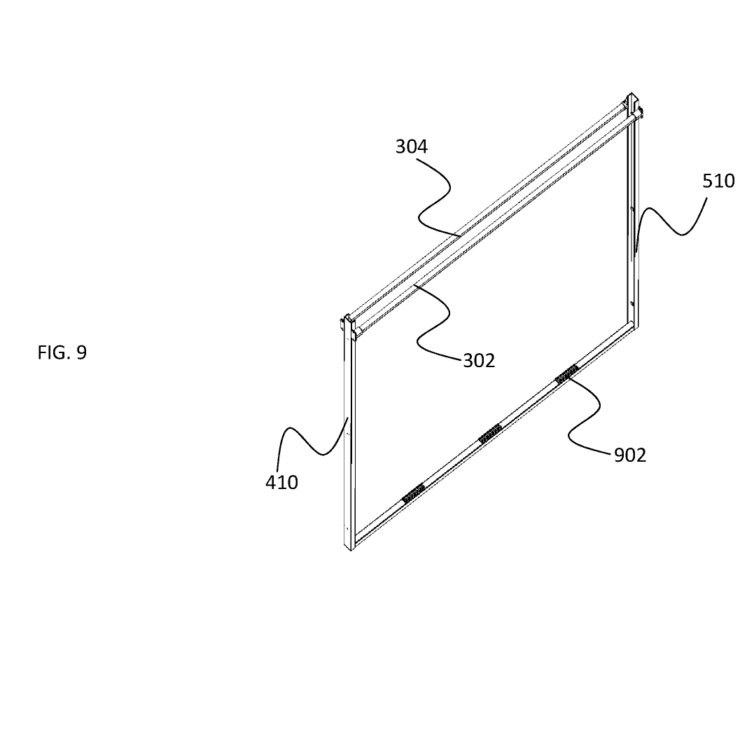

FIG. 9 is a perspective view of an embodiment of a frame structure of the sliding door system, according to an example embodiment. The frame structure as mentioned above may include a vertically aligned left frame 410 and an opposing vertically aligned right frame 510. Additionally, as illustrated in the present embodiment, the frame structure may also include a bottom frame 902, wherein each end of the bottom frame may be coupled to the lower end of the left and right frames. The bottom frame, similar to the left and right frames may comprise an elongated L-shaped body defining a channel The L-shaped body may be configured so that the bottom ends of the doors may fit inside the channel of the L-shaped body. The bottom, left and right frames may be coupled together along with the front rail 302 and rear rail 304. The frame structure as illustrated in FIG. 9 is configured to span between the walls (illustrated as 1204, 1202 in FIG. 12) of a shower.

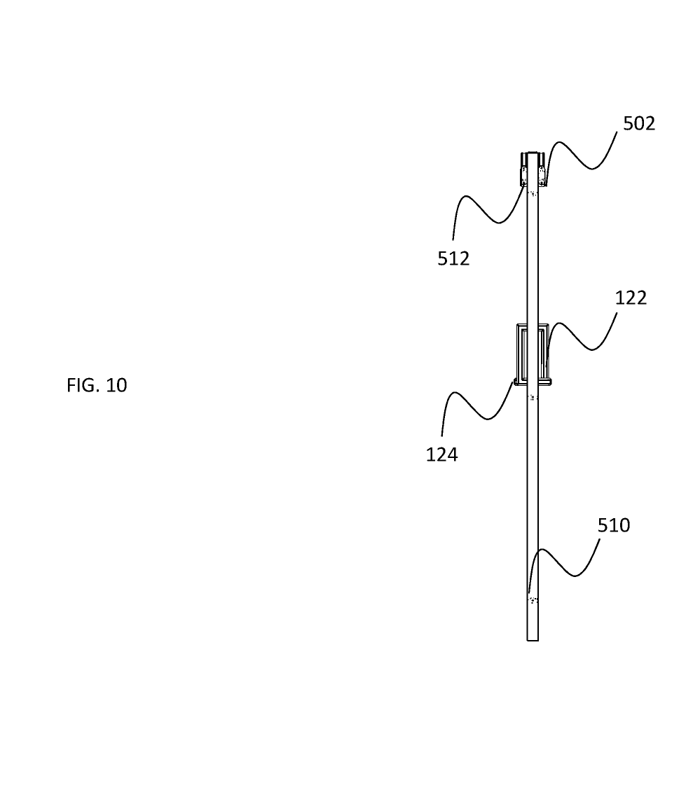

FIGS. 10-12 will be discussed together. FIG. 10 is a side view of the doors inside the frame structure of the sliding door system and FIG. 11 is a top view the doors inside the frame structure, according to an example embodiment. FIG. 12 is a top view of the sliding door system attached to shower falls defining a shower enclosure, according to an example embodiment. In FIGS. 10-12, the siding or system is fully assembled and in the closed position. The front door 302 is positioned in front of and parallel to rear door 304. The rollers of the front door, 420, 640 front door are positioned above the front rail 302 thereby allowing the front door to the vertically aligned and positioned within the frame structure. In operation, a user may apply force to the handle 122 of the door such that the rollers can rotate thereby allowing the door to move between the open and closed position. Similarly, the rollers 620, 520 of the rear door are positioned above the rear rail 304 thereby allowing the rear door to be vertically aligned and positioned within the frame structure. Similarly, to the operation of the front door, a user may apply force to the handle 124 of the door such that the rollers can rotate thereby allowing the door to move between the open and closed position. In operation, when the door is opened, the stops of the other door prevent the door from damaging the frame.

FIG. 13 is a perspective view of the apparatus of FIG. 1 showing a close-up view of the bottom 902 of the frame, according to one embodiment. FIG. 13 shows that bottom 902 includes various guides 1302 located along a bottom of the rectangular shaped frame, wherein the guides may have a rough W-shape, which includes one or more gutters for accepting the first and second glass doors. Thus, the guides 1302 act as guides for the doors as they slide open and closed. Guides 1302 may be comprised of a rubber or elastic material.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A dual sliding door apparatus, comprising:
a rectangular shaped frame configured for attachment to two opposing walls and a floor, the frame creating an opening configured for ingress and egress into a shower enclosure;
a top of the frame comprising a first rail parallel to, and on an identical horizontal plane as, a second rail, such that the first rail is horizontally separated from the second rail;
a first glass door sized so as to cover about one half of the opening;
a first pair of roller wheels coupled to a top of the first door, the first pair of roller wheels including a concave outer surface designed to mate with the first rail, such that the first door rolls on the first rail;
a second glass door sized so as to cover about one half of the opening;
a second pair of roller wheels coupled to a top of the second door, the second pair of roller wheels including a concave outer surface designed to mate with the second rail, such that the second door rolls on the second rail;
a first stop coupled to an outer circumference of the first glass door, wherein the first stop extends outwards such that it prevents the second door from rolling past the first stop; and
a second stop coupled to an outer circumference of the second glass door, wherein the second stop extends outwards such that it prevents the first door from rolling past the second stop.

2. (canceled)

3. (canceled)

4. The apparatus of claim 1, further comprising at least one guide located along a bottom of the rectangular shaped frame, wherein the at least one guide includes gutters for accepting the first and second glass doors.

5. The apparatus of claim 4, further comprising
a first mount for coupling said first rail to a first of said two opposing walls,
a second mount for coupling said first rail to a second of said two opposing walls,
a third mount for coupling said second rail to a first of said two opposing walls,
a fourth mount for coupling said second rail to a second of said two opposing walls.

6. (canceled)

7. The apparatus of claim 5, further comprising:
a first rubber bumper coupled to the first stop, wherein the rubber bumper is configured to contact the second door; and
a second rubber bumper coupled to the second stop, wherein the rubber bumper is configured to contact the first door.

8. The apparatus of claim 1, wherein the apparatus is in the closed position wherein the first and second glass doors are arranged so as to obstruct substantially the entire opening and wherein the apparatus is in the open position wherein the first and second glass doors are arranged such that substantially half of the opening is free from obstruction.

9. The apparatus of claim 8, further comprising at least one horizontal handle coupled to each of the first and second glass doors.

10. The apparatus of claim 9, further comprising at least one vertical handle coupled to each of the first and second glass doors.

11. A dual sliding door apparatus, comprising:
a rectangular shaped frame comprising a bottom bar, a right side bar, a left side bar, and a top portion including a first rail parallel to, and on an identical horizontal plane as, a second rail, such that the first rail is horizontally separated from the second rail;
a first door sized so as to cover about one half of the opening;
a first pair of roller wheels coupled to a top of the first door, the first pair of roller wheels including a concave outer surface designed to mate with the first rail, such that the first door rolls on the first rail;
a second door sized so as to cover about one half of the opening;
a second pair of roller wheels coupled to a top of the second door, the second pair of roller wheels including a concave outer surface designed to mate with the second rail, such that the second door rolls on the second rail, and the second door is parallel to the first door;
a first stop coupled to an outer circumference of the first door, wherein the first stop extends outwards such that it prevents the second door from rolling past the first stop; and
a second stop coupled to an outer circumference of the second door, wherein the second stop extends outwards such that it prevents the first door from rolling past the second stop.

12. (canceled)

13. (canceled)

14. The apparatus of claim 11, further comprising at least one guide located along the bottom bar of the rectangular shaped frame, wherein the at least one guide includes gutters for accepting the first and second doors.

15. The apparatus of claim 14, further comprising
a first mount for coupling said first rail to a first of said two opposing walls,
a second mount for coupling said first rail to a second of said two opposing walls,
a third mount for coupling said second rail to a first of said two opposing walls,
a fourth mount for coupling said second rail to a second of said two opposing walls.

16. (canceled)

17. The apparatus of claim 15, further comprising:
a first rubber bumper coupled to the first stop, wherein the rubber bumper is configured to contact the second door; and
a second rubber bumper coupled to the second stop, wherein the rubber bumper is configured to contact the first door.

18. The apparatus of claim 11, wherein the apparatus is in the closed position wherein the first and second doors are arranged so as to obstruct substantially the entire opening and wherein the apparatus is in the open position wherein the first and second doors are arranged such that substantially half of the opening is free from obstruction.

19. The apparatus of claim 18, further comprising at least one horizontal handle coupled to each of the first and second doors.

20. The apparatus of claim 19, further comprising at least one vertical handle coupled to each of the first and second doors.
